(19) United States
(12) Patent Application Publication
(10) Pub. No.: US 2010/0050112 A1
(43) Pub. Date: Feb. 25, 2010

(54) System and method of immediate translation display

(75) Inventors: Chaucer Chiu, Taipei (TW); Tao Zhou, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/230,052

(22) Filed: Aug. 22, 2008

(51) Int. Cl. G06F 3/048

(52) U.S. Cl. 715/781; 715/856

(57) ABSTRACT

A system of immediate translation display and the method thereof are provided. The system and method aims to solve the problem that the graphical user interface of the Linux operating system cannot translate the displayed word and display the translated item. In this case, a pre-load program is loaded by the operating system in advance. After extracting the display words at where the mouse cursor stays, they are translated and displayed. This achieves the effect of enhancing the reading convenience in the graphical user interface of the Linux operating system.

### BACKGROUND OF THE INVENTION

1. Field of Invention

The invention relates to a system of immediate translation display and the method thereof and, in particular, to a system of immediate translation display for the convenience of reading on the Linux operating system (OS) and the method thereof.

2. Related Art

Since the invention of computers, the interactions between a user and a computer are done through the so-called user interface. In the conventional text mode of the OS, the display device shows a boring text interface. The user operates the computer by keying in commands on a keyboard. In such an OS, the user has to memorize a lot of commands in order to rapidly enter commands. Therefore, the graphical user interface (GUI) has been invented. Such a GUI converts some of the command entering action into clicking certain function icons using such input devices as mouse cursor, keyboard, or touch-control panel. This simplifies the action of entering commands and thus increases the convenience for the user.

The GUI consists of graphical elements. Such graphical elements include windows, function icons, menus, scroll bars, and various graphical starting elements. Each graphical element usually has displayed word, such as the text description for the function icon, the functional menu of a word editing window, or some displayed text content. However, such text may not be displayed in the user's mother language. The user may not recognize some of the words or phrases. In this case, the user cannot conveniently use the program when reading words on the GUI.

In view of this, the Windows OS has the system and method for real-time translating the words appearing in the GUI and displaying the translated items. When the user lets the mouse cursor stay on some displayed word in the GUI, the words are extracted and translated. The translated item is displayed to the user. This increases the convenience in reading and understanding the GUI. Such a function relies very much upon the powerful ability of extracting parameters from graphical elements in the Windows OS. A specific function (e.g., hook) is called to extract words. This achieves the goal of immediate translation and display. However, the Linux OS does not have the function of extracting words in graphical elements. Therefore, it is impossible to perform immediate translation and display translated items in the GUI of the Linux OS.

The above-mentioned is the long-lasting problem in the GUI of the Linux OS. It is imperative to provide a technique to solve the problem.

### SUMMARY OF THE INVENTION

In view of the foregoing, an objective of the invention is to provide a system of immediate translation display and the method thereof.

The disclosed immediate translation display system applies to the GUI of the Linux OS. The GUI contains a mouse cursor and at least graphical element. The system comprises: a storing module for storing at least one translation datum; a receiving module for receiving an opening parameter to open the graphical element and receiving coordinate parameters of the mouse cursor as it moves over the GUI; a loading module for loading corresponding dynamic functions of the graphical element after receiving the opening parameter; a timing module for timing when the mouse cursor stays at the coordinate parameters; an extracting module for extracting the displayed word according to the coordinate parameters by reading the dynamic functions of the graphical element when the coordinate parameters are continuously received over a threshold; a translating module for extracting the translation datum of the corresponding displayed word; and a displaying module for displaying the graphical element corresponding to the opening parameter and displaying the translation datum.

The disclosed immediate translation display method applies to the GUI of the Linux OS. The GUI contains a mouse cursor and at least graphical element. The method includes the steps of: receiving a corresponding opening parameter when opening the graphical element; loading a dynamic function corresponding to the graphical element; displaying the graphical element corresponding to the opening parameter; receiving the coordinate parameters of the mouse cursor as it moves over the GUI and timing; when the coordinate parameters are continuously received over a threshold, reading the dynamic function of the graphical element according to the coordinate parameters; extracting the display words corresponding to the coordinate parameters in the dynamic function; extracting the translation datum corresponding to the displayed word; and displaying the translation datum.

Through the above-mentioned technique, the invention enables the user to conveniently read words in the GUI of the Linux OS.

### BRIEF DESCRIPTION OF THE DRAWINGS

The invention will become more fully understood from the detailed description given herein below illustration only, and thus is not limitative of the present invention, and wherein:

FIG. 1 shows the structure of the disclosed immediate translation display system.

FIG. 2 is a flowchart of the disclosed immediate translation display method.

FIGS. 3A and 3B are schematic views of an embodiment showing how the translation datum is displayed in the GUI according to the invention.

### DETAILED DESCRIPTION OF THE INVENTION

The present invention will be apparent from the following detailed description, which proceeds with reference to the accompanying drawings, wherein the same references relate to the same elements.

Those Chinese characters shown in the following descriptions or in the drawings are just mentioned for describing the embodiments and are substantially irrelevant to any technical matters.

The implementation of the invention will be explained using drawings and embodiments. We explain how the invention loads in a preload program in advance when the OS starts, how it extracts the displayed word at where the mouse cursor stays, and how the display words are translated and the translated item is displayed. This solves the problem that in the Linux OS it is impossible to translate display words in the GUI and display the translated item. Moreover, the following describes how to enable the user to easily read words in the GUI of the Linux OS.

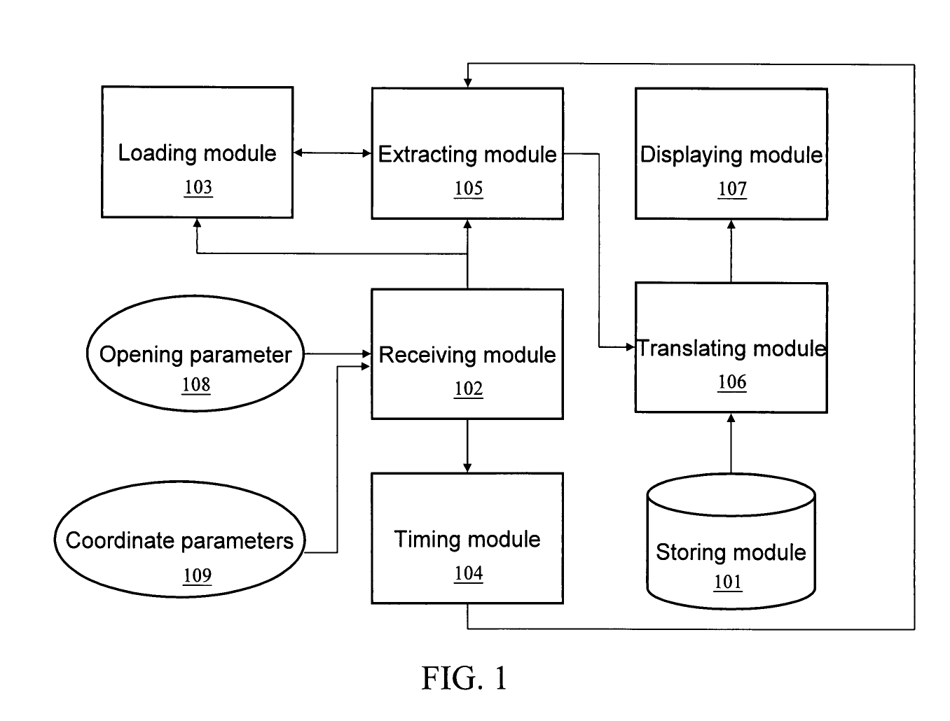

First, please refer to FIG. 1 for a structural diagram of the disclosed immediate translation display system. It schematically shows how various modules in the disclosed system operate. The disclosed immediate translation display system applies to the GUI of the Linux OS. The GUI contains a mouse cursor and at least one graphical element. The disclosed system includes: a storing module 101, a receiving module 102, a loading module 103, a timing module 104, an extracting module 105, a translating module 106, and a displaying module 107.

The storing module 101 stores at least one translation datum.

The receiving module 102 receives an opening parameter 108 for opening the graphical element in the GUI. It also receives the coordinate parameters 109 of the mouse cursor as it moves over the GUI.

The loading module 103 loads in the dynamic function of the graphical element corresponding to the received opening parameter 108. The graphical element is composed of many attributes and functional routines, all of which are contained in the dynamic function. When the user enters the opening parameter 108 via the GUI, the loading module 103 loads in the dynamic function of the graphical element to be opened at the same time, so that the contents in the currently opened graphical element can be read.

The timing module 104 starts timing when the receiving module 102 receives the coordinate parameters 109 of the mouse cursor staying at a position. It further determines whether the time has exceeded a threshold. Once the threshold is reached, it notifies the extracting module 105.

The extracting module 105 receives the coordinate parameters 109 transmitted from the receiving module 102. When the timing module 104 determines that the threshold has been reached, the extracting module 105 extracts the displayed word by reading the dynamic function of the graphical element corresponding to the location given by the coordinate parameters 109.

For example, suppose the user stops the mouse cursor at a particular function icon. The timing module 104 starts timing. Assuming that the time threshold is 1.5 seconds, the timing module 104 notifies the extracting module 105 to extract the displayed word of the function icon on which the mouse cursor stops when the time exceeds 1.5 seconds. For example, if the user stops the mouse cursor on the word “File” of a particular window, the receiving module 102 obtains the coordinate parameters 109 of “File.” When the stop time exceeds the time threshold, the extracting module 105 reads the dynamic function of the window on which the mouse stays. The displayed word “File” is obtained by the method of computing the coordinate parameters 109.

The translating module 106 searches for a translation datum in the storing module 101 that corresponds to the displayed word extracted by the extracting module 105.

The displaying module 107 displays the graphical element corresponding to the opening parameter 108 and displays the translation datum corresponding to the displayed word. The translation datum can be shown in a window. Moreover, the display window is next to the coordinate parameters of the mouse cursor.

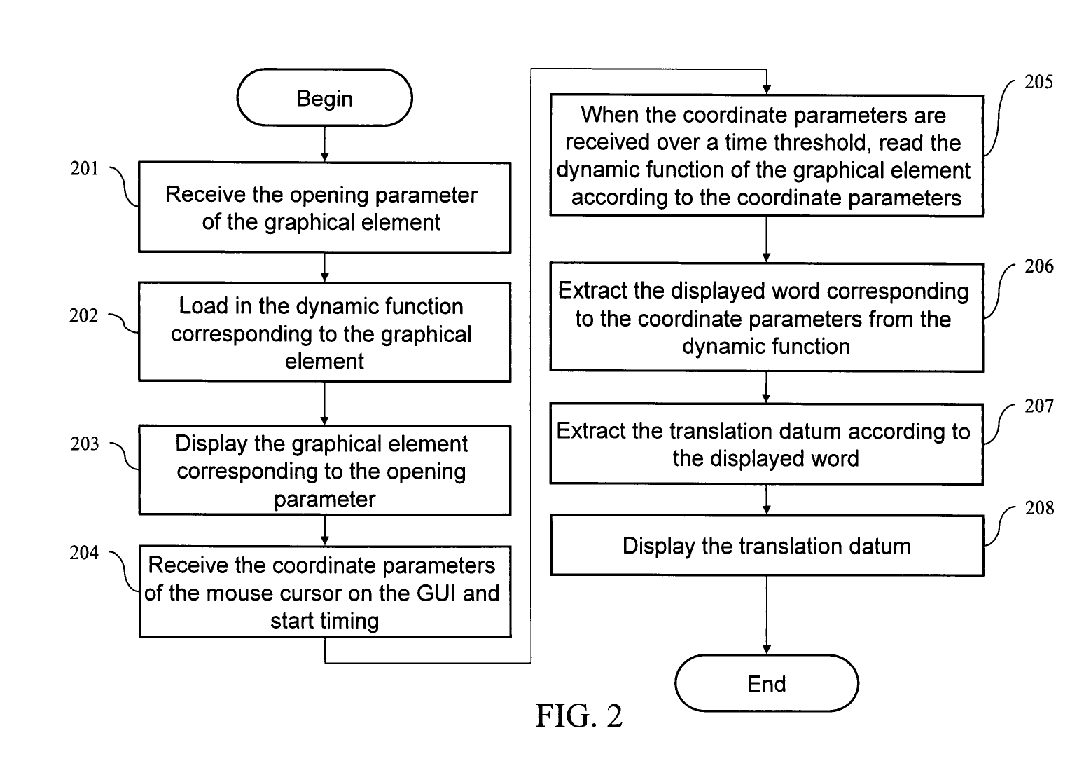

In the following, the disclosed immediate translation display method is explained with reference to FIG. 2. This method applies to the GUI of the Linux OS. The GUI contains the mouse cursor and at least one graphical element. First, the receiving module 102 receives the opening parameter 108 of the graphical element (step 201). For example, when the user wants to execute a particular element by mouse clicking, the opening parameter 108 is generated. After the receiving module 102 receives the opening parameter 108, the loading module 103 loads in the dynamic function of the graphical element corresponding to the opening parameter (step 203). For example, suppose the user selects the function icon of “Recycle Bin.” The loading module 103 then loads in the dynamic function of “Recycle Bin.” Afterwards, the displaying module 107 displays the graphical element corresponding to the opening parameter (step 204).

When the user moves the mouse cursor in the GUI, the receiving module 102 receives the coordinate parameters 109 of the mouse cursor. The timing module 104 starts timing (step 205). When the time of the mouse cursor staying at the coordinate parameters reaches a threshold, the extracting module 105 reads the dynamic function of the graphical element corresponding to the coordinate parameters (step 206). For example, when the user stops the mouse cursor on the displayed word of the function icon “Recycle Bin,” the timing module 104 starts timing. When the time reaches the threshold, the extracting module 105 learns that the mouse cursor stays at the function icon of “Recycle Bin” according to its coordinate parameters. Afterwards, the dynamic function is read from the preloaded program according to the graphical element, thereby obtaining the displayed word (step 207). The translating module 106 then extracts the translation datum corresponding to the displayed word from the storing module 101 (step 208). Finally, the displaying module 107 displays the translation datum extracted by the translating module 106 (step 209). The translation datum can be displayed in a window. The position of this window can be determined from the mouse cursor.

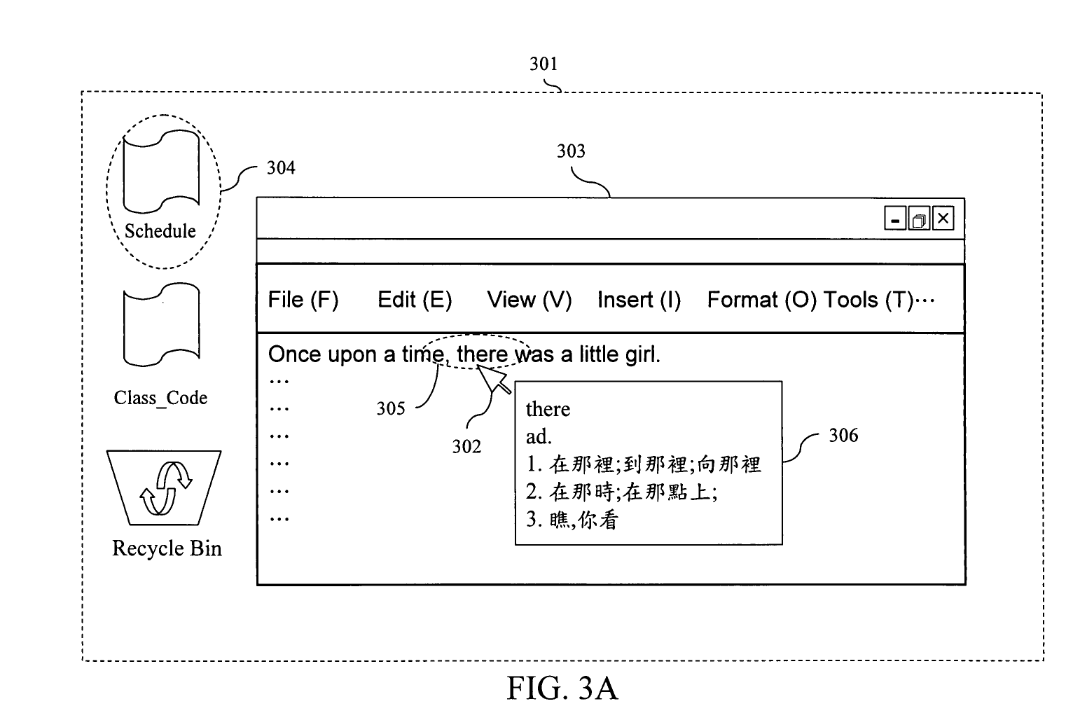

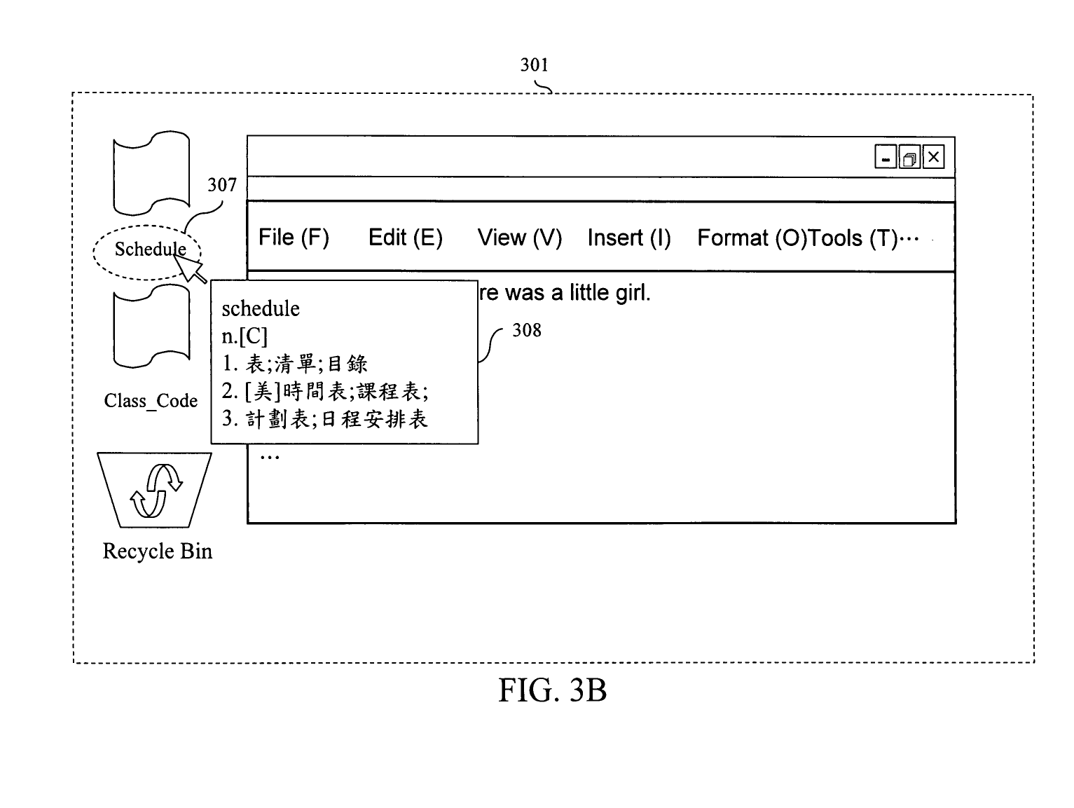

In the following, please refer to FIGS. 3A and 3B. An embodiment is used to explain the invention.

A GUI 301 is shown in FIG. 3A. The GUI 301 contains graphical elements such as a mouse cursor 302, a word editing window 303, a function icon 304, etc. When the user opens the word editing window 303, the loading module 103 loads in the dynamic function corresponding to the word editing window 303 and, at the same time, the opened word editing window 303 is displayed by the displaying module 107.

When the user leaves the mouse cursor 302 at the word editing window 303 in the GUI 301, the receiving module receives the coordinate parameters of the mouse cursor 302. At the same time, the timing module starts timing. When the time reaches a threshold, the extracting module extracts the corresponding graphical element according to the coordinate parameters of the mouse cursor, i.e., the word editing window 303. Afterwards, the dynamic function of the corresponding word editing window 303 is read. The coordinate parameters are computed to obtain the displayed word 305 “there.” After the extraction of the displayed word 305 “there,” the translating module extracts the translation datum corresponding to the displayed word 305 “there” from the storing module. The extraction result is displayed by the displaying module in a display window 306. Likewise, as shown in FIG. 3B, when the user stops the mouse cursor 302 at the displayed word 307 “Schedule” of the function icon 304, the translation datum corresponding to the displayed word 307 “Schedule” is also displayed in a display window 308. Moreover, the display positions of the display windows 307, 308 can be determined by the mouse cursor 302.

In summary, when applying the invention to the GUI of the Linux OS, a preload program is loaded into the Linux OS in advance. After extracting the display word at the place where the mouse cursor stops, it is translated and displayed. Such a mechanism can simulates the functions of extracting parameters of a graphical element and extracting words directly using a special function in the Windows OS. The invention thus solves the problem of no translation for displayed words in the GUI of the Linux OS. Reading text in the GUI of the Linux OS therefore becomes much easier.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An immediate translation display system for a graphical user interface (GUI) in the Linux operating system (OS) containing a mouse cursor and at least one graphical element, comprising:
a storing module, which stores at least one translation datum;
a receiving module, which receives an opening parameter for opening the graphical element and coordinate parameters of the mouse cursor in the GUI;
a loading module, which loads in a dynamic function of the corresponding graphical element after receiving the opening parameter;
a timing module, which starts timing when the receiving module receives the coordinate parameters of the mouse cursor stopping at some position and determines whether the time has reaches a time threshold;
an extracting module, which continuously receives the coordinate parameters transmitted from the receiving module and, when the timing module determines that the time threshold has been reached, extracts a displayed word by reading the dynamic function of the graphical element corresponding to the coordinate parameters;
a translating module, which extracts the translation datum corresponding to the displayed word; and
a displaying module, which displays the graphical element corresponding to the opening parameter and the translation datum.

2. The immediate translation display system of claim 1, wherein the displaying module further opens a display window to display the translation datum.

3. The immediate translation display system of claim 3, wherein the display window is located around the coordinate parameters of the mouse cursor.

4. An immediate translation display method for a graphical user interface (GUI) in the Linux operating system (OS) containing a mouse cursor and at least one graphical element, comprising the steps of:
receiving an opening parameter for opening a graphical element;
loading in a dynamic function corresponding to the graphical element;
displaying the graphical element corresponding to the opening parameter;
receiving coordinate parameters of the mouse cursor in the GUI and starting timing;
reading the dynamic function of the graphical element according to the coordinate parameters when the coordinate parameters are continuously received over a time threshold;
extracting a displayed word corresponding to the coordinate parameters from the dynamic function;
extracting a translation datum corresponding to the displayed word; and
displaying the translation datum.

5. The method of claim 4 further comprising the step of displaying the translation datum in a display window.

6. The method of claim 5, wherein the display window is located around the coordinate parameters of the mouse cursor.
